(19) United States
(12) Patent Application Publication
(10) Pub. No.: US 2019/0011184 A1
(43) Pub. Date: Jan. 10, 2019

(54) REFRACTORY ANCHOR FOR A FURNACE REFRACTORY TILE

(71) Applicant: TATA STEEL NEDERLAND TECHNOLOGY B.V., Velsen-Noord (NL)

(72) Inventors: Florus Hermanus BEUKEMA, DEN OEVER (NL); Paulus VAN BEURDEN, HEERHUGOWAARD (NL)

(73) Assignee: TATA STEEL NEDERLAND TECHNOLOGY B.V., Velsen-Noord (NL)

(21) Appl. No.: 16/064,215

(22) PCT Filed: Dec. 9, 2016
(86) PCT No.: PCT/EP2016/080460

§ 371 Date: Jun. 20, 2018

(30) Foreign Application Priority Data
Jan. 22, 2016 (EP) 16152404.6

(51) Int. Cl. F27D 1/14; B28B 11/24; B28B 1/14

(52) U.S. Cl. CPC F27D 1/141; B28B 1/14; B28B 11/243

(57) ABSTRACT

A refractory anchor for a refractory tile for a furnace and to a method to manufacture such a refractory anchor, wherein the refractory anchor has an overall truncated cone shape, wherein the refractory anchor is divided in at least two parts with one or more dividing planes between the parts which run from bottom plane to top plane of the truncated cone shaped refractory anchor.

### FIELD OF THE INVENTION

The invention relates to a refractory anchor for a furnace refractory roof tile or wall tile as used in high temperature furnaces in for instance the steel industry as well as to a method for the manufacturing of such an refractory anchor.

### BACKGROUND OF THE INVENTION

With high temperature furnaces it is of importance to reduce heat losses as much as possible in order to be able to control the temperature in the furnace and to minimize the heating costs. To this end inside furnace walls are provided with a lining of refractory material that is secured to the walls.

A known method to mount refractory material to the inside of furnace walls and roof is by means of anchoring. A specific anchor is the so called ceramic refractory anchor, often a conical or shaped brick of a refractory material. The refractory anchor is often used to suspend insulation material in the form of refractory tiles from a structural support. These refractory tiles are layered tiles with layers of different refractory materials.

The life time of refractory tiles used in for instance re-heat furnaces to re-heat steel slabs are in the order of 8-20 years. The refractory anchor should have a life time that is at least equal to and preferably longer than that of the refractory tile to be sure that the refractory tiles remain suspended. However, due to the heating and cooling cycles the refractory anchor is subjected to large stress variations. This requires a refractory anchor that can withstand these stress variations over a prolonged period of time, in particular for the refractory tiles with a life time of 15-20 years.

The refractory tiles need to have excellent insulation properties in order to safe on heating costs as much as possible and at the same time the manufacturing costs should be low to be able to recover the costs within a reasonable period of time. These requirements oppose each other and a suitable balance should be found.

### OBJECTIVES OF THE INVENTION

It is an objective of the present invention to provide a refractory anchor that is capable to withstand variations in stress due to heating and cooling cycles over a prolonged period of time.

It is another objective of the present invention to provide a refractory anchor with a life time that is at least equal to the lifetime of the refractory tile that is clamped or suspended by means of the anchor brick.

It is another objective of the present invention to provide a refractory anchor with a life time of 10-20 years.

It is another objective of the present invention to provide a refractory tile with excellent insulation properties.

It is another objective of the present invention to provide a refractory tile that can be manufactured against a cost price that can be recovered within a reasonable period of time.

### DESCRIPTION OF THE INVENTION

The invention relates to a refractory anchor as defined in claims 1-10, a method for the manufacturing of a refractory anchor as defined in claims 11-13 and a mould for the manufacturing of a refractory anchor as defined in claims 13-15.

According to a first aspect of the invention one or more of the objectives of the invention are realized by providing a refractory anchor for a refractory tile for a high temperature furnace, wherein the refractory anchor has an overall truncated cone shape, characterised in that the refractory anchor is divided in three or more parts and wherein radial dividing planes run from bottom plane to top plane of the truncated cone shaped refractory anchor.

With a high temperature furnace a furnace is meant wherein the temperature is such that the hot side of the refractory material should be able to withstand temperatures in the range of 1300-1400° C.

A refractory anchor is subjected to stresses during heating and cooling cycles and depending on the temperature rate these stresses might increase up to and over 50% of the maximum stress that a refractory anchor can initially withstand (i.e., its strength). With normal temperature rates in steel slab re-heat furnaces the stresses will be in the order of 20-25% of the strength. Repeated heating and cooling cycles wherein the refractory anchor is subjected to high stresses will be detrimental to the life time of the refractory anchor. It was found that by dividing the refractory anchor in three or more parts these stresses during the cooling cycles can be substantially lowered.

It was found that dividing the refractory anchor in two parts resulted locally in an increase of the stresses to which the refractory anchor is subjected in comparison to the original one-part refractory anchor. For that reason the refractory anchor should at least be divided in three parts with radial dividing planes. These dividing planes start from the centre line of the cone shape and extend in radial direction. It was found that dividing the refractory anchor in three or four parts resulted in a substantial decrease of the stresses occurring in the refractory anchor.

A two-part refractory anchor is disclosed in AT320701 which has a truncated cone shape with oval shaped bottom and top plane with a dividing plane through the centre and parallel to the smallest axis of the oval.

The refractory anchor is preferably divided in parts of the same size and shape to have the same stresses and stress effects in each of the parts. Further the centre line or axis of the truncated cone shape is at the right angles to the bottom plane and top plane wherein both the bottom plane and top plane are circular planes. Moreover, parts of the same size will facilitate the manufacturing of the refractory anchor.

The refractory anchor is preferably shaped with a first cone part and a second cone part each with a truncated cone shape, with a shoulder part as transition between the first and second cone parts. The bottom plane of the second cone part is at the hot side when in use and wherein the diameter of the imaginary bottom plane of the first cone part is less than the diameter of the imaginary top plane of the second cone part. The advantage of this shape with a shoulder part is that it provides an improved support for the refractory tile.

According a further aspect the height of the first cone part is larger than the height of the second cone part. By lowering the shoulder part in the direction of the hot side the stresses occurring in the second cone part are decreased.

Preferably the height of the second cone part is less than 65% of the height of the first cone part. According to a further aspect the height of the second cone part is between 35% and 50% of the height of the first cone part. It was found that lowering the shoulder part beyond that does not result in any further overall improvement. The height ranges of the first and second cone part together with the height of the shoulder part form the total height of the refractory anchor. The total height of the refractory anchor is in a range of 230-400 mm, wherein the top plane diameter of the first cone part is in a range of 80-145 mm and the bottom plane diameter of the second cone part is in a range of 165-210 mm.

With a three and four part refractory anchor the diameters of the bottom and top plane may in general be taken larger to ensure mechanical stability. The ranges for such three or four part refractory anchor will overlap with those of an undivided refractory anchor.

According to a further aspect the shoulder part is concavely curved with a radius of curvature in the range of 5-30 mm. The curvature of the shoulder part results in lower stresses occurring in the shoulder part, however there is a limit to the curvature. With a larger radius of curvature the area wherein the stresses associated with the shoulder part occur increases such that the effect of a larger radius of curvature is cancelled out. Good results in lowering the stresses are realized wherein the shoulder part is concavely curved with a radius of curvature in the range of 15-25 mm.

According to a further aspect the opening angle or cone angle of the first cone part and/or second cone part are in the range of 2-15°. With such an opening angle the anchor provides good support for the refractory tile and the stresses occurring in the refractory anchor are kept within limits.

Further a method is provided for the manufacturing of a refractory anchor for a refractory tile for a furnace, wherein the refractory anchor has an overall truncated cone shape and wherein the refractory anchor is divided in at least two parts, comprising the steps of:
providing a mould for the refractory anchor divided in parts,
filling the mould with a refractory moulding compound,
firing the refractory anchor, and
applying a mortar between the parts of the refractory anchor.
   The filling of the mould is done under pressure such that the mould is completely filled with refractory moulding compound. Besides the filling under pressure the compound mass could further be stamped and/or the mould vibrated to get an optimal filling of the mould.

After the firing of the refractory anchor the parts are fixed to each other by applying a mortar between the parts of the refractory anchor. To this end an air curing mortar is used that is capable to withstand the temperatures to which it will be exposed in the furnace. The mortar is applied in such a thickness that the finale refractory anchor has the dimensions as designed. These dimensions correspond with the internal dimensions of the mould. In this manner a perfect match with the anchor hole in the refractory tile can be realized. The mortar has a strength that is less than the strength of each of the parts of the refractory anchor. Moreover, the mortar has a certain flexibility such that the refractory anchor can adapt to the complementary shaped recess provided in the refractory tile to receive the refractory anchor.

Besides a division in a number of parts the method further includes that a shape is formed in the refractory anchor to receive an anchor bolt, which shape is complementary to the anchor bolt.

According to a further aspect a mould is provided for the manufacturing of a refractory anchor for a refractory tile for a furnace, wherein the refractory anchor has an overall truncated cone shape and wherein the refractory anchor is divided in at least three parts, and wherein the mould has an overall truncated cone shape which is open at one side and closed at the opposite side, a protrusion in the closed side which is shaped for the refractory anchor to receive an anchor bolt and one or more dividing plates which run from the closed side to the open side of the mould.

It is further provided that the dividing plates have a thickness in the range of 1-5 mm, preferably 1-3 mm and typically 1-2 mm. Preferably the dividing plates have a thickness which corresponds with the thickness or the final thickness of the layer mortar that is applied between the parts of the refractory anchor.

### BRIEF DESCRIPTION OF THE DRAWINGS

The invention will be further explained on hand of the example shown in the drawing, in which:

FIG. 1A,B show a side view of respectively a refractory anchor divided in three parts and a view of an undivided refractory anchor,

FIG. 2A-C show top view, side view and bottom view of a refractory anchor divided in four parts, and

FIG. 3 shows a graph with the stresses a three different locations for a single part refractory anchor up to a 4 part refractory anchor.

### DETAILED DESCRIPTION OF THE DRAWINGS

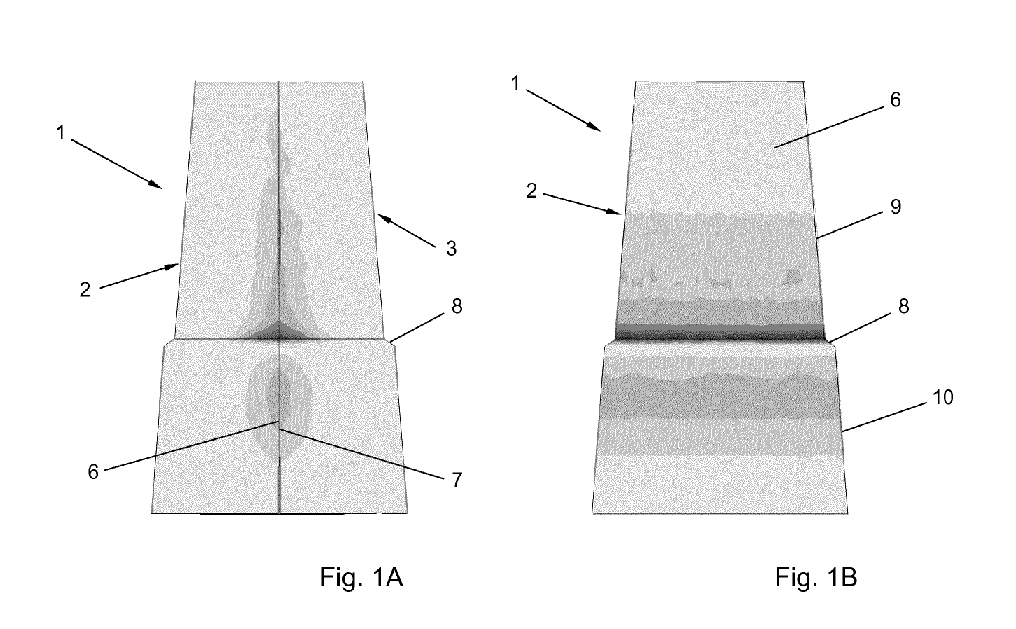

In FIG. 1A a refractory anchor 1 is shown that is divided in three parts, with only the parts 2, 3 visible, wherein the darker shading is indicative of the maximum stresses occurring in the anchor when cooling down. The stresses with a three-part anchor occur at the joining faces 6,7 of the three-part anchor 1 at or near the shoulder 8 between the first cone part 9 and the second cone part 10.

The side view of an undivided refractory anchor 1 of FIG. 1B clearly shows that the stresses diminish in downward and upward direction from the shoulder 6.

These stresses with a three-part anchor only occur around the division because of the stress relieving effect of the joints. With an anchor in one piece these stresses occur over the entire anchor.

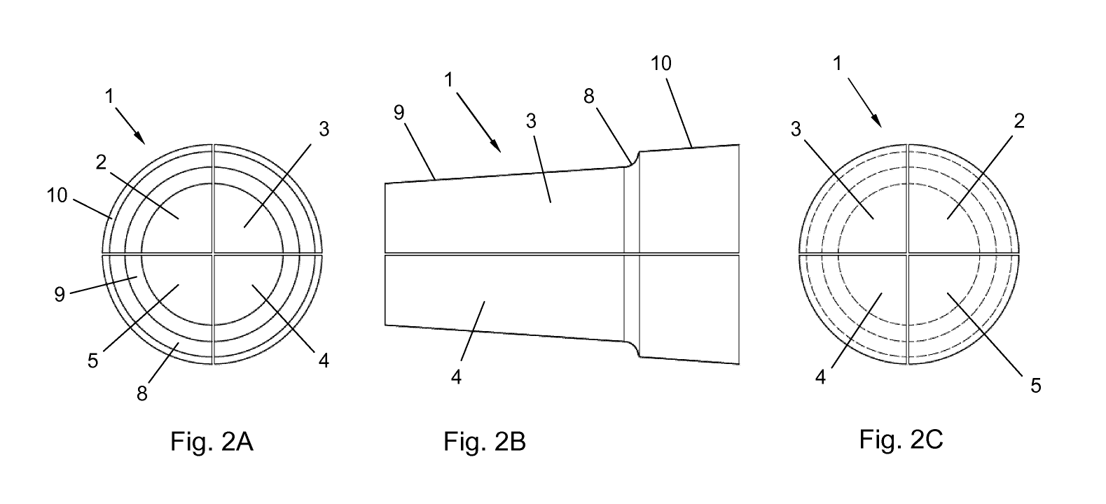

FIG. 2A shows a top view of a refractory anchor 1 which is divided in four parts 2, 3, 4, 5 wherein the stresses as occur in the three-part anchor are far less and also less than in an anchor made in one piece. The respective side view of FIG. 2B and the bottom view of FIG. 2C show the in this case symmetrical division of the refractory anchor in four parts.

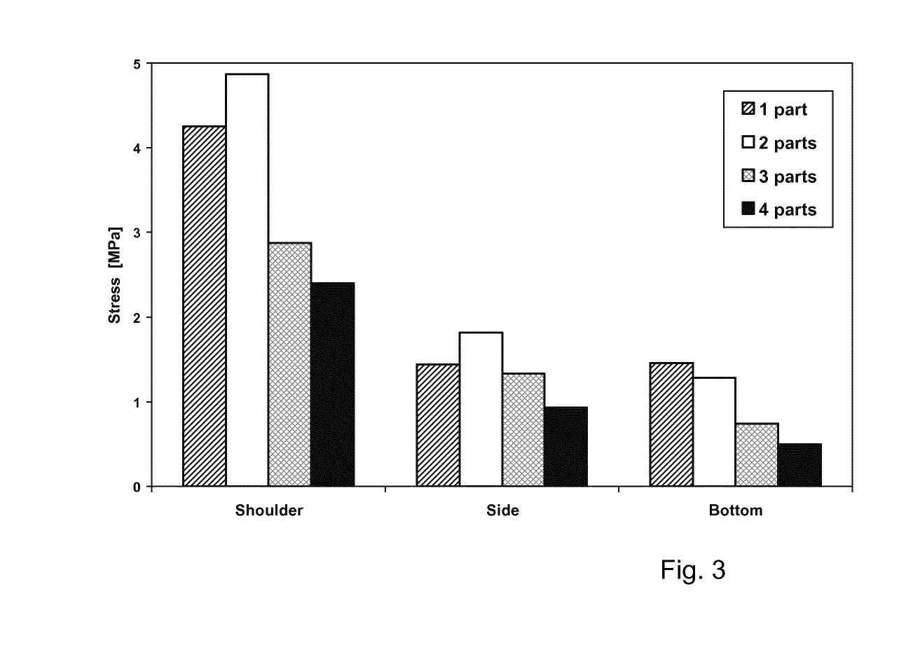

In FIG. 3 a diagram is shown with the stresses occurring with the cooling down of and anchor divided in two, three and four parts. The stresses are given as occurring at or near the shoulder, the side and the bottom, wherein the side is the cone envelope of the second cone part 10 and the bottom is the part of the second cone part 10 that faces the interior of the re-heat furnace and which is subjected to the highest temperature differences over time.

Directly apparent from the diagram is that the two-part anchor is the least favourable embodiment with the largest stresses occurring at the shoulder and the side face of the anchor. Only with regard to the bottom part the one-piece form is worse. This is related to the fact that in the two-part anchor an increased, but localized around the division plane, bending moment occurs which increases the stress intensity. This increased bending moment is less pronounced for the three and four-part anchors.

The three part form is clearly favourable over the one-piece and two-part form anchor with the largest decrease of the occurring stresses being at or near the shoulder part and a significant decrease of the stresses occurring at the bottom of the anchor. The stresses at the side are less significant reduced with respect to the one piece form, but still there is a decrease.

The four part anchor shows even further decreased stresses and here the decrease of the stresses occurring at the side and the bottom are significantly reduced in comparison with the stresses occurring at the side and bottom of a three part anchor.

1. A refractory anchor for a refractory tile for a furnace, wherein the refractory anchor has an overall truncated cone shape, wherein the refractory anchor is divided in three or more parts and wherein radial dividing planes run from bottom plane to top plane of the truncated cone shaped refractory anchor.

2. The refractory anchor according to claim 1, wherein the parts of the refractory anchor are identically shaped.

3. The refractory anchor according to claim 1, wherein the refractory anchor has a first cone part and a second cone part each with a truncated cone shape, with a shoulder part as transition between the first and second cone parts.

4. The refractory anchor according to claim 3, wherein the bottom plane of the second cone part is at a hot side when in use and wherein the diameter of the bottom plane of the first cone part is less than the diameter of the top plane of the second cone part.

5. The refractory anchor according to claim 1, wherein height of the first cone part is larger than height of the second cone part.

6. The refractory anchor according to claim 5, wherein the height of the second cone part is less than 65% of the height of the first cone part.

7. The refractory anchor according to claim 5, wherein the height of the second cone part is between 35% and 50% of the height of the first cone part.

8. The refractory anchor according to claim 1, wherein the shoulder part is concavely curved with a radius of curvature in the range of 5-30 mm.

9. The refractory anchor according to claim 1, wherein the shoulder part is concavely curved with a radius of curvature in the range of 15-25 mm.

10. The refractory anchor according to claim 1, wherein an opening angle of the first cone part and/or second cone part are in the range of 2-15°.

11. A method for the manufacturing of a refractory anchor for a refractory tile for a furnace, wherein the refractory anchor has an overall truncated cone shape and wherein the refractory anchor is divided in at least three parts, comprising the steps of:
providing a mould for the refractory anchor divided in parts,
filling the mould with a refractory moulding compound,
firing the refractory anchor, and
applying a mortar between the parts of the refractory anchor.

12. The method according to claim 11, wherein the mortar is an air curing mortar.

13. The method according to claim 11, wherein a complementary shape to receive an anchor bolt is formed in the refractory anchor.

14. A mould for the manufacturing of a refractory anchor for a refractory tile for a furnace, wherein the refractory anchor has an overall truncated cone shape and wherein the refractory anchor is divided in at least two parts,
wherein the mould has an overall truncated cone shape which is open at one side and closed at the opposite side, a protrusion in the closed side which is shaped for the refractory anchor to receive an anchor bolt and one or more dividing plates which run from the closed side to the open side of the mould.

15. The mould according to claim 14, wherein the dividing plates have a thickness in the range of 1-5 mm.

16. The method of claim 11, wherein the refractory anchor has an overall truncated cone shape, wherein the refractory anchor is divided in three or more parts and wherein radial dividing planes run from bottom plane to top plane of the truncated cone shaped refractory anchor.

17. The method of claim 11, wherein the parts of the refractory anchor are identically shaped.

18. The method of claim 11, wherein the refractory anchor has a first cone part and a second cone part each with a truncated cone shape, with a shoulder part as transition between the first and second cone parts.
